(19) United States
(12) Patent Application Publication
(10) Pub. No.: US 2005/0215290 A1
(43) Pub. Date: Sep. 29, 2005

(54) Mobile terminal and voice output adjustment method thereof

(75) Inventors: Masaki Wakabayashi, Yokohama (JP); Kyoichi Nakaguma, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/923,221

(22) Filed: Aug. 20, 2004

(30) Foreign Application Priority Data
Mar. 26, 2004 (JP) 2004-091061

(51) Int. Cl. H04M 1/00

(52) U.S. Cl. 455/563; 455/575.1

(57) ABSTRACT

An earphone microphone 1 is connected to a mobile terminal 10 by radio waves. A user can preset each of levels of volume and tone quality that he/she considers as appropriate for each of the predetermined use states inside his/her mobile terminal via a volume setting section 15 and a tone quality setting section 16. When a change in an internal use state is followed by the acquisition of a use state after the change, volume setting information 32 and tone quality setting information 33 both associated with the use state are read out from a memory. Volume and tone quality are each adjusted individually for each of a mobile terminal microphone 11, a mobile terminal ear receiver 12, an external microphone 2, and an earphone 3.

### CLAIM of PRIORITY

The present application claims priority from Japanese application serial no. 2004-091061, filed on Mar. 26, 2004, the content of which is hereby incorporated by reference into this application.

### BACKGROUND OF THE INVENTION

The present invention relates to a mobile terminal and a voice output adjustment method thereof.

In recent years there has been a wide spread of mobile terminals such as cellular phones, personal digital assistants, and mobile computers, for example. For some mobile terminals, there are also products that allow video watching besides voice calls, as represented by cellular phones. Video watching includes watching of TV program delivered via communications networks, calls while watching the image of the party (video phones), and the reproduction of picture image data saved in the terminal.

Take as an example a case where a user gets an incoming external call while watching an image on his/her mobile terminal and a voice call is started. The user could ignore the incoming call and continue to watch the image. If, however, the user answers the call and starts a voice call, voice involved in video reproduction will become noise, thus interrupting a conversation. Therefore, the user will lower the volume of the image being reproduced or suspend image reproduction to make a voice call.

Note that technologies are known for making adjustments in response to the opening/close operation of a mobile terminal (Japanese Patent Laid-open No. 8-237158) and for categorizing incoming-call situations by time and place and making volume adjustments (Japanese Patent Laid-open No. 2002-261878).

As described in the above-mentioned patent documents, it is possible to make automatic adjustments of the volume of a mobile terminal. In the related art, however, no consideration is substantially given to volume adjustments based on a change in the internal use state of the mobile terminal. In the related art, volume adjustments are made simply based on a state change such as whether the use of the mobile terminal is started or not, but not based on a change from one internal use state to another.

The internal state of the mobile terminal changes in a various way depending on the user's use of the mobile terminal, such as a change from video watching to voice call. As the multi-functioning of the mobile terminals progresses, the various internal states thereof are increased, thus resulting in frequent changes among individual internal states. In the related art, the user needs to make adjustments each time according to a change in the internal state, thus making the mobile terminal less easy to use.

Recent aging societies have led to an increased use of a mobile terminal with a hearing aid. For the use of a mobile terminal with a hearing aid, the performance of the hearing aid changes with an increasing internal use state of the mobile terminal. Therefore, a smooth conversation and watching require volume adjustments to be made for each of the mobile terminal and the hearing aid. In such a case, the user also must make volume adjustments for each of the mobile terminal and the hearing aid, thus making these units less easy to use.

In view of the forgoing problem, the present invention has been made and it is an object of the present invention is to provide a mobile terminal and its voice output adjustment method for allowing proper volume and tone quality adjustments to be made according to a change in the internal use state of the mobile terminal.

### SUMMARY OF THE INVENTION

A mobile terminal according to the present invention comprises a mobile terminal body having at least a voice input section and a voice output section and an external unit connected to the mobile terminal body and having at least another voice input section and another voice output section. The mobile terminal also comprises a storage section for storing adjustment information pre-registered for each predetermined internal use state managed in the interior of the mobile terminal; a use state acquisition section for acquiring a change in the internal use state managed in the interior of the mobile terminal; and an adjustment section for reading out the adjustment information corresponding to the predetermined internal use state from the storage section and, based on the adjustment information, adjusting at least one of an input state of each of the voice input sections and an output state of each of the voice output sections, if the internal use state acquired is the predetermined internal use state.

The voice input section is a sound input section for inputting not only human voice but also sounds. For example, a microphone and the like can be used as the voice input section. Th voice output section is a sound output section for outputting not only human voice but also sounds. For example, ear receivers, earphones and the like can be use as the voice output section. The external unit is a voice input/output unit provided on the exterior of the mobile terminal body and connected to the mobile terminal. The external unit can be configured as a headset or an earphone microphone. The external unit is connected to the mobile terminal body via radio waves such as in short-range wireless communications or via optical communications.

The storage section can be configured, for example, as a semiconductor memory, a hard disk unit or the like fixedly attached to the interior of the mobile terminal body. Alternatively, the storage section can also be configured as a storage medium removable from the mobile terminal body.

The storage section has adjustment information pre-stored therein for each predetermined internal use state. The internal use state means a use state managed in the interior of the mobile terminal. The internal use states also include an intermediate state that is passed by in a change from one internal use state to another. A predetermined internal use state information means a use state set beforehand among a plurality of internal use state. The predetermined internal use state information can include waiting, voice call, video watching, and voice call and video watching, for example.

The adjustment information is control information used to adjust either volume or tone quality, or both in a predetermined internal use state. Each piece of adjustment information can be configured to contain a set value for adjustment provided for the output system of each voice output section. In other words, individual adjustments can be made for each voice output section.

The use state acquisition section acquires a change in an internal use state. Providing a state change detection section for detecting a change in an internal use state, for example, allows the use state acquisition section to acquire an internal use state after the change.

When the predetermined internal use state is acquired, the adjustment information associated with the predetermined internal use state is read out from the storage section. The adjustment section make individual adjustments of the input state of two or more voice input sections and the output state of two or more voice output sections, based on the adjustment information. The adjustment section is capable of completely suspending inputs of voice input sections and outputs of voice output sections individually or outputting voice at the maximum output from the voice output section, for example. The adjustment section can be provided for both the mobile terminal body and the external unit.

Providing a registration section for registering each piece of adjustment information in the storage section, for example, allows the user to register adjustment information according to his/her own acousis and lifestyle (use of his/her mobile terminal and the like).

In this way, the present invention individually adjusts each voice input and output of two or more systems according to a change in an internal use state in a mobile terminal, thus improving the usability of the mobile terminal.

The adjustment section is capable of individually adjusting each of both volume and tone quality. The adjustment section is capable of adjusting volume and tone quality, independently. The adjustment section is capable of adjusting both volume and tone quality. Note, for example, that the complete suspension of voice outputs (volume: 0) requires no tone quality adjustments.

A voice output adjustment method for a mobile terminal according to another aspect of the present invention is a voice output adjustment method for adjusting the voice output of a mobile terminal comprising a mobile terminal body and an external unit connected to the mobile terminal body via radio waves and having a plurality of voice output systems that can be used simultaneously. The method comprises the steps of: storing adjustment information for each predetermined internal use state managed in the interior of the mobile terminal; storing the adjustment information registered; detecting a change in an internal use state managed in the interior of the mobile terminal; acquiring an internal use state after the change, based on the internal use state detected; determining whether or not the internal use state detected is the predetermined internal use state; reading out the adjustment information corresponding to the predetermined internal use state if the internal use state detected is determined to be the predetermined internal use state; and individually adjusting each voice output of a plurality of voice output systems, based on the adjustment information read out.

Note that it is possible to configure a function of registering adjustment information with the storage section (a registration function), a function of acquiring a change in an internal use state (an internal use state acquisition function), and a function of reading out adjustment information in accordance with a predetermined internal use state and allowing the individual adjustment of at least one of an input and an output (an adjustment function), as a program allowing a computer of a mobile terminal to execute. It is also possible to configure the above voice output adjustment method as a program allowing the computer of the mobile terminal to execute. A program according to the present invention can be stored in various types of storage medium such as a semiconductor memory and an optical disc for distribution, for example. Alternatively, a program according to the present invention can be transmitted via a communication medium such as the Internet, for example.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing the outline of a function configuration of a mobile terminal according to an embodiment of the present invention;

FIG. 2 is a block diagram showing the outline of a hardware configuration of a mobile terminal;

FIGS. 3A and 3B are an explanatory diagram showing a plurality of use states managed in the interior of a mobile terminal and an explanatory diagram showing the way a change is made between each two individual use states, respectively;

FIG. 4 is an explanatory diagram showing the configuration of volume setting information;

FIG. 5 is an explanatory diagram showing the configuration of tone quality setting information;

FIG. 6 is an explanatory diagram showing a frame format of a setting screen for making volume and tone quality settings;

FIG. 7 is a flow chart showing an entire process for acousis fitting;

FIG. 8 is a flow chart showing a process for registering acousis fitting data;

FIG. 9 is a flow chart showing a process for interlocking acousis fitting;

FIG. 10 is an explanatory diagram showing a specific example of volume and tone quality settings; and

FIG. 11 is an explanatory diagram showing a frame format of the way adjustments are made for voice inputs/outputs of a plurality of systems.

### DESCRIPTION OF THE EMBODIMENTS

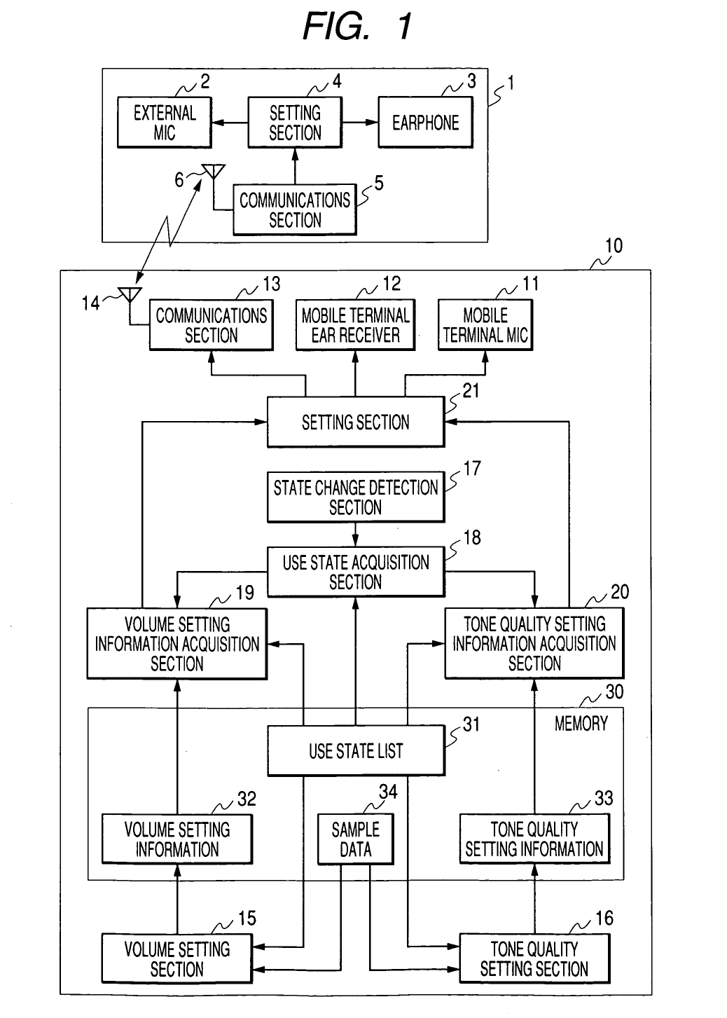

Preferred embodiments of the present invention will be described below with reference to FIGS. 1 to 11. In an embodiment of the present invention, a mobile terminal body 10 comprising a mobile terminal microphone 11 and a mobile terminal ear receiver 12 (hereinafter referred to as a “terminal body”) is connected to an earphone microphone 1 comprising a microphone 2 and an earphone 3 by radio waves, as described below in detail. If there is a change in a use state managed in the interior of the mobile terminal, individual automatic adjustments are made for voice inputs/outputs of a plurality of systems, based on the change in the internal use state.

FIG. 1 is a functional block diagram showing a function configuration of a mobile terminal according to the present embodiment. The earphone microphone 1, an example of an “external unit,” comprises, as its main functions, an external microphone 2, an earphone 3, a setting section 4, and a communications section 5. The earphone microphone 1 is worn around a user's head.

The external microphone 2 is distinguished from the mobile terminal microphone 11 that the terminal body 10 has. The external microphone 2 is located near the mouth of the user. The external microphone 2 can also be formed integrally with the earphone 3 if the microphone 2 is configured as a bone conduction microphone.

The setting section 4 makes individual adjustments for voice input states (sensitivity) from the external microphone 2 and voice output states from the earphone 3. The communications section 5 makes wireless communications with the terminal body 10 via an antenna 6. For instance, the communications section 5 communicates with the terminal body 10 via wireless communications in a short range of scores of centimeters to 10 meters or so. The communications section 5 may be capable of communicating with the terminal body 10 in a range of under scores of centimeters or more than 10 meter or so. Note that the earphone 3 may also be provided with a display, for example.

The terminal body 10 comprises a mobile terminal microphone 11, a mobile terminal ear receiver 12, a communications section 13 with an antenna 14, a volume setting section 15, a tone quality setting section 16, a state change detection section 17, a use state acquisition section 18, a volume setting information acquisition section 19, a tone quality setting information acquisition section 20, a setting section 21, and a memory 30.

The mobile terminal microphone 11 is so provided as to be located near the mouth of a user if, for example, the user uses the terminal body 10. The mobile terminal ear receiver 12 is provided for the terminal body 10 at another location that is away from the mobile terminal microphone 11. The communications section 13 communicates with the earphone microphone 1 via the antenna 14.

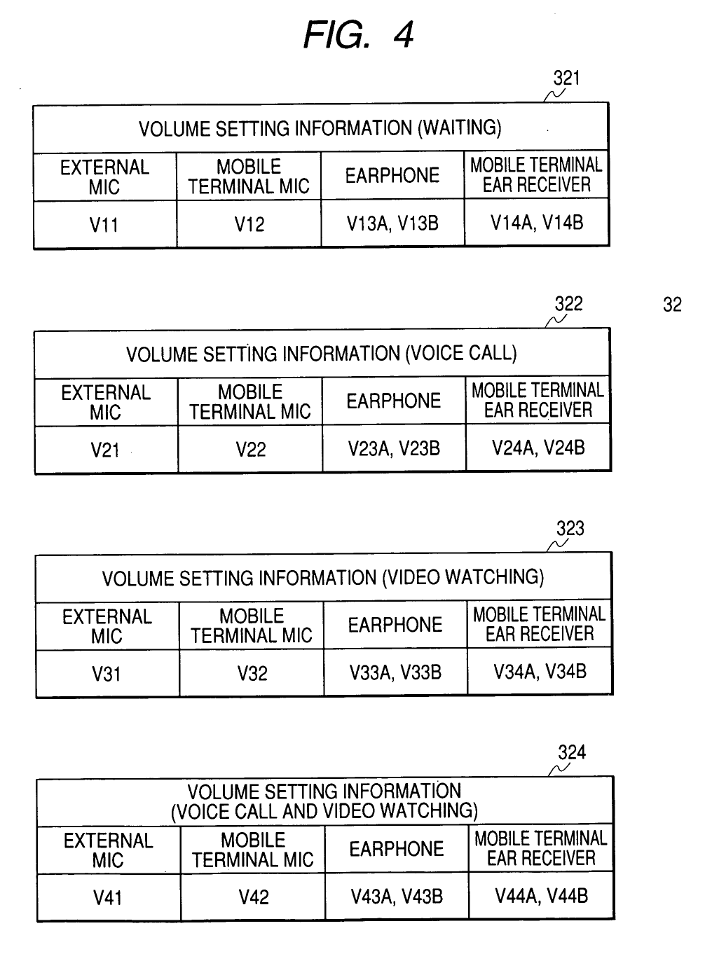

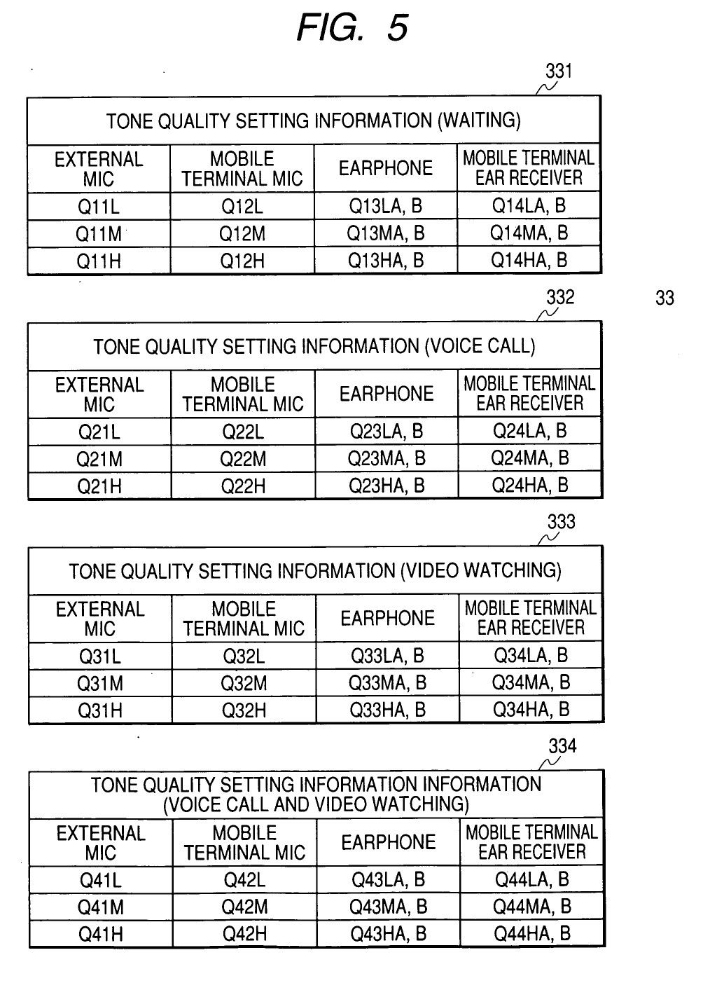

The volume setting section 15 is capable of individually setting the volumes of the respective voice input/output systems for each of the internal use states. Information set by the volume setting section 15 is stored in the memory 30 as volume setting information 32. The volume setting information 32 will be further described later with reference to FIG. 4. The tone quality setting section 16 is capable of individually setting the tone qualities of the respective voice input/output systems for each of the internal use states. Information set by the tone quality setting section 16 is stored in the memory 30 as tone quality setting information 33. Tone quality setting information will be further described later with reference with FIG. 5.

The volume setting section 15 and the tone quality setting section 16 together constitute an example of a “registration section.” These setting sections 15 and 16 are realized on a user interface of the terminal body 10. A specific example of the registration section will be further described later.

The state change detection section 17 detects a change in an internal use state managed in the interior of the terminal body 10. Use states managed in the interior of the mobile terminal include waiting, outgoing call, incoming call, voice call, and video watching, for example. When the state change detection section 17 detects a change in a use state, the use state acquisition section 18 acquires a decision about what is the use state after the change.

The volume setting information acquisition section 19 reads out and acquires volume setting information 32 corresponding to a change in an internal use state from the memory 30 when the change is acquired by the use state acquisition section 18. Similarly, the tone quality setting information acquisition section 20 reads out and acquires tone quality setting information 33 corresponding to a use state from the memory 30.

The setting section 21 receives volume setting information 32 from the volume setting information acquisition section 19. The setting section 21 receives tone quality setting information 33 from the tone quality setting information acquisition section 20. The setting section 21 individually adjusts each input and output state for the mobile terminal microphone 11 and the mobile terminal ear receiver 12, based on these volume setting information 32 and tone quality setting information 33. The setting section 21 also sends information about the setting of the external microphone 2 or earphone 3 contained in volume setting information 32 and tone quality setting information 33 to the earphone microphone 1 via the communications section 13.

The memory 30 can be configured as a semiconductor memory such as a flash memory, for example. The memory 30 has stored use state list information 31, volume setting information 31, volume setting information 32, tone quality setting information 33, and sample data 34. Sample data 34 are data used to make volume and tone quality adjustments (fitting). Sample data 34 can be prepared for each use state, like sample data for voice call and sample data for video watching, for example. Alternatively one or a small number of sample data can be used in common for each use state.

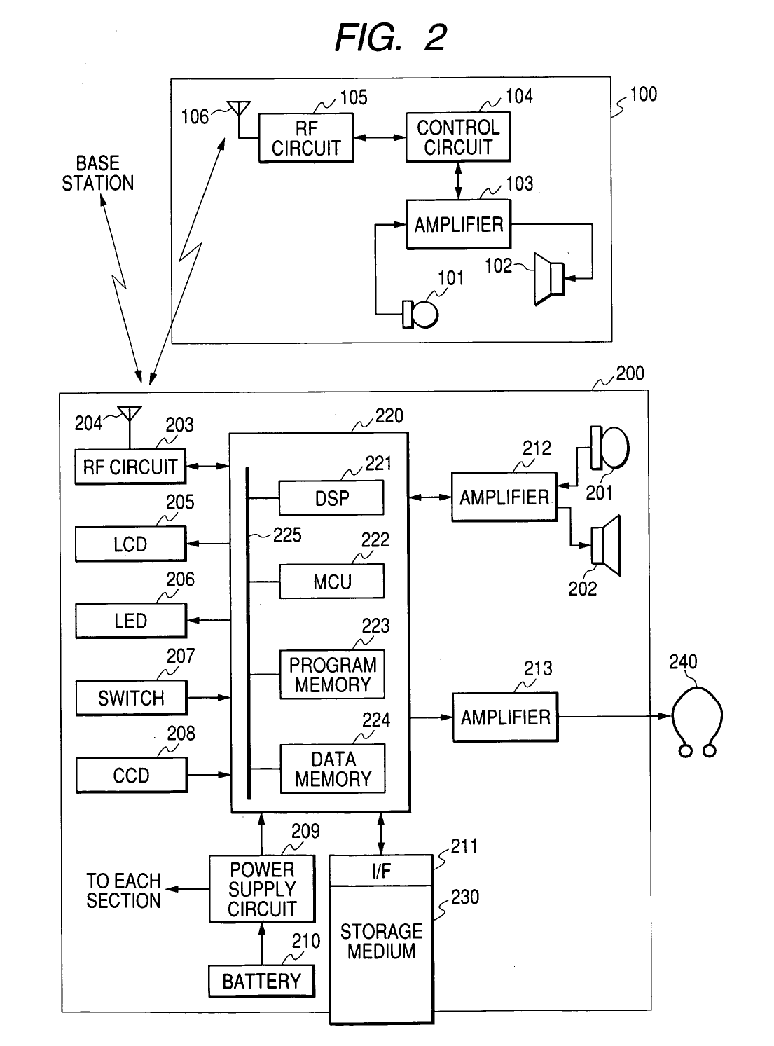

FIG. 2 is a block diagram showing the outline of a specific hardware configuration of a mobile terminal. For example, the earphone microphone 100 comprises an external microphone 101, an earphone 102, an amplifier 103, a control circuit 104, an RF circuit 105, and an antenna 106. The control circuit 104 corresponds to the setting section 4 shown in FIG. 1. The RF circuit 105 and the antenna 106 correspond to the communications section 5 and the antenna 6, respectively, both shown in FIG. 1. Note that the earphone microphone 100 can be provided with a battery and a power supply circuit, but not shown in FIG. 2.

A terminal body 200 comprises a mobile terminal microphone 201, a mobile terminal ear receiver 202, an RF circuit 203, an antenna 204, an LCD 205, an LED 206, a switch 207, a CCD 208, a power supply circuit 209, a battery 210, an interface circuit (I/F) 211, amplifiers 212 and 213, a controller 220, and a storage medium 230.

The mobile terminal microphone 201 corresponds to the mobile terminal microphone 11 shown in FIG. 1. The mobile terminal ear receiver 202 corresponds to the mobile terminal ear receiver 12 shown in FIG. 1. The RF circuit 203 and the antenna 204 correspond to the communications section 13 and the antenna 14, respectively, both shown in FIG. 1. The setting sections 15, 16, the setting information acquisition sections 19, 20, the state change detection section 17, the use state acquisition section 18, and the setting section 21, each shown in FIG. 1, can be implemented by means of mainly the controller 220.

The LCD (Liquid Crystal Display) 205 is an example of an display section, but the example is not limited to a liquid crystal display. Other display units such as a plasma display, for example, can be used as an display section. The LED 206 is used to display states of a mobile terminal (incoming call, power ON state, etc.) Note that the LED 206 can be omitted if the LCD 205 is used to display these states.

The switch 207 is configured as a group of push-buttons that is composed of a ten keyboard switches and a power switch, for example. Note that part or all of the switch group 207 can be omitted if information is inputted through a touch screen of the LCD 205 or through voice instructions.

The CCD 208 is an example of an imaging section and the example is not limited to the use of a CCD (Charge Coupled Device). Other devices such as a CMOS (Complementary Metal-Oxide Semiconductor), for example, may be used as an imaging section. The CCD 208 is used for the user to image his/her portrait or outside scenery. The CCD 208 can also be utilized for the user to make what is called a video phone call.

The power supply circuit 209 produces a predetermined voltage, based on the supply voltage from the battery 210 and supplies each component such as the controller 220 with power. Note that a power supply is not limited to the battery 210. A photoelectric conversion circuit (a solar cell) and a thermoelectric conversion circuit, for example, can also be used as a power supply.

The interface circuit (I/F) 211 is provided to receive and send data from and to an external storage medium 230. The storage medium 230 is composed of a semiconductor memory such as a flash memory, a small hard disc unit or a small optical disc unit, for example.

The controller 220 performs various communications processing and controls for a mobile terminal. The controller 220 comprises a DSP (Digital Signal Processor) 221, an MCU (Micro Control Unit), or MPU (Micro Processing Unit) 222, a program memory 223, and a data memory 224. These components are connected to one another via a bus 225.

The MCU 222 executes part or all of the control processing in the terminal by reading out and executing micro-codes stored in the program memory 223. The data memory 224 is used as a work area and has user data (graphics files and address book data and the like) stored.

The memory 30 shown in FIG. 1 can be configured as the data memory 224. Alternatively, the memory 30 can also be configured as the external storage medium 230. Alternatively, the memory 30 can also be composed of the data memory 224 and the storage medium 230. For example, volume setting information 32 and tone quality setting information 33 can be stored in the storage medium 230, thereby easily making a new mobile terminal take over volume setting information 32 from the old one, such as even if the user gets the new mobile terminal.

Note that a headphone 240 is wire connected to the mobile terminal and not the same product as the earphone microphone 100.

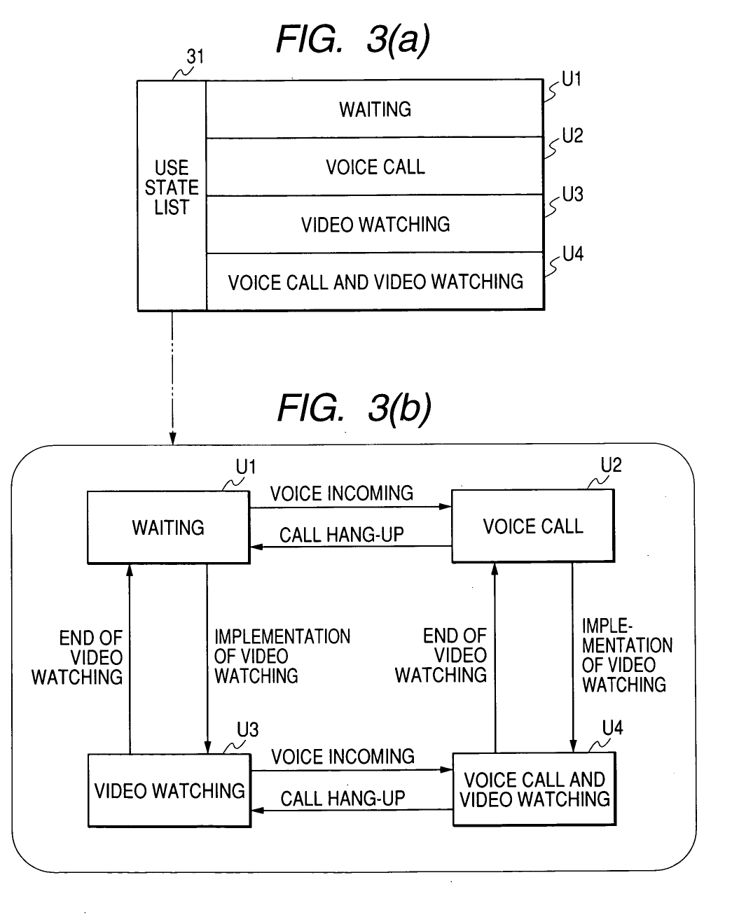

FIGS. 3A and 3B are explanatory diagrams showing a predetermined use state registered to the use state list information 31. As shown in FIG. 3A, predetermined internal use states for a mobile terminal can include waiting U1, voice call U2, video watching U3, and voice call and video watching U4, for example.

FIG. 3B is a diagram showing a transition in state for each of the states U1 to U4. Waiting U1 is a waiting state where no voice communications are made over a mobile communications network.

When an incoming call from the outside is received and a call is started while the mobile terminal is in waiting U1, a transition is made from waiting U1 to voice call U2. If the call is hung up, a transition is made from voice call. U2 to waiting U1.

When the user starts video watching while the mobile terminal is in waiting U1, a transition is made from waiting U1 to video watching U3. If, for example, the user watches digital television available via land broadcasts or reproduces picture images saved in the terminal body 10 while the terminal body 10 is in waiting U1, a transition is made from waiting U1 to video watching U3. When the user finishes video watching, a transition is made from video watching U3 to waiting U1.

If an incoming call is received from the outside and a voice call is started while the mobile terminal is in video watching U3 or if video watching is started while the mobile terminal is in voice call U2, a transition is made to voice call and video watching U4. In other words, voice call and video watching U4 is a state where, for example, a voice call available over a mobile communication network and video watching such as digital television available on land broadcasts are each executed.

Note that a state where video and voice are outputted at the same time on a video phone can be classified as voice call U2. If voice output with video watching and voice output through a voice call are each performed separately, it is classified as voice call and video watching U4.

When a call is hung up while the mobile terminal is in voice call and video watching U4, a transition is made to video watching U3. When video watching is ended while the mobile terminal is in voice call and video watching U4, a transition is made to voice call U2.

FIG. 4 is an explanatory diagram showing an example of the configuration of volume setting information 32. The volume setting information 32 can be set for each predetermined use state. That is to say, volume setting information 32 can be composed of volume setting information 321 for waiting U1, volume setting information 322 for voice call U2, volume setting information 323 for video watching U3, and volume, setting information 324 for voice call and video watching U4.

“V11” refers to a set value for a first device in a first use state U1. “V23” is a set value for a third device for a second use state U2. In FIG. 4, the external microphone 2 is expressed as a first device, the mobile terminal microphone 11 as a second device, the earphone 3 as a third device, and the mobile terminal ear receiver 12 as a fourth device, for the convenience of description. Note that for classification as a voice input device and an voice output device, the external microphone 2 can be called a first input device, the mobile terminal microphone 11 a second input device, the earphone 3 as a first output device, and the mobile terminal ear receiver 12 as a second output device. Note that the order of the first and the second can be interchanged.

Two types of voices, i.e., a voice from a voice call and a voice associated with video watching can be outputted to each of the voice output devices, i.e., the earphone 3 and the mobile terminal ear receiver 12. In other words, the voices of two or more systems are outputted to voice output devices and a set value is designed to be settable individually for each system. For example, “V13A” is information for adjusting the volume of a voice call outputted from the third device (earphone 3) in the first use state U1. “V13B” is information for adjusting the voice for video watching outputted from the third device (earphone 3) in the first use state U1.

FIG. 5 is an explanatory diagram showing an example of the configuration of tone quality setting information 33. The tone quality setting information 33 can also be prepared for each of the predetermined use states U1 to U4. That is to say, the tone quality setting information 33 can be composed of tone quality setting information 331 for waiting U1, tone quality setting information 332 for voice call U2, tone quality setting information 333 for video watching U3, and tone quality setting information 334 for voice call and video watching U4.

Note that setting information 32, 33 need not always be prepared for all of the use states U1 to U4. The user can set these types of setting information in a range that is necessary for him/her. The user may, for example, prepare volume setting information 32 and tone quality setting information 33 for initial setting in advance. In this embodiment, the volume setting information 32 and tone quality setting information 33 together are in some cases called acousis fitting data.

For the tone quality setting information 33, audible frequencies are divided into two or more regions, such as a low sound region (L), an intermediate sound region (M), and a high sound region (H), and set values are stored in the respective frequency regions. For example, “Q12L” refers to a set value for the low sound region for the second device (mobile terminal microphone 11) in the first use state U1. For example, “Q23HA” refers to a set value for the high sound regions used for outputting voices for system A (e.g., a voice call) from the third device (earphone 3) in the second use state U2.

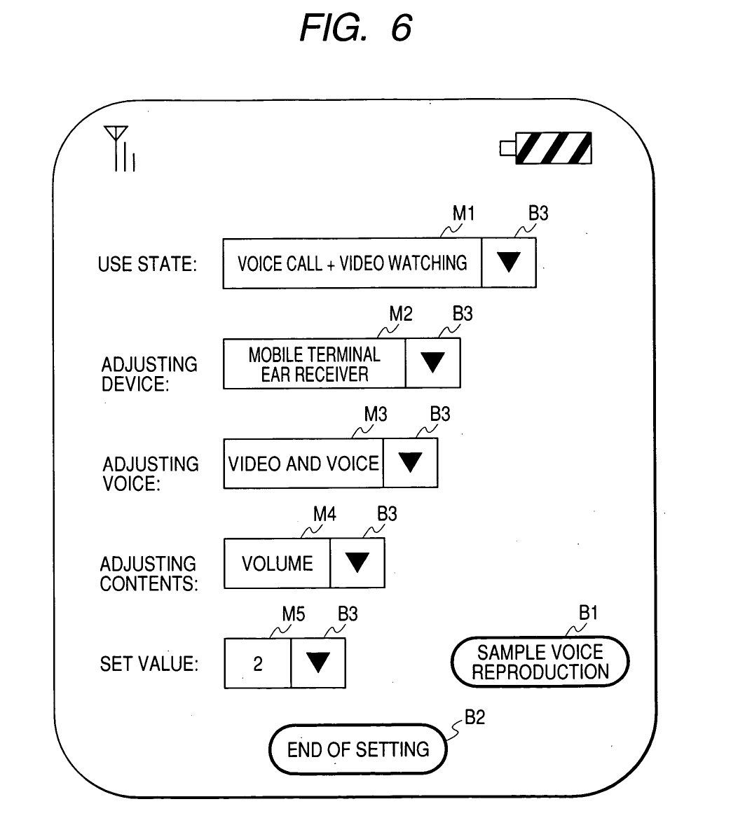

FIG. 6 is an explanatory diagram showing an example of a setting screen for registering the volume setting information 32 and the tone quality setting information 33 with the memory 30 of the terminal body 10. The screen corresponds to the volume setting section 15 and the tone quality setting section 16.

The setting screen can, for example, display a plurality of selection menus composed of a use state selection section M1, an adjusting device selection section M2, an adjusting voice selection section M3, an adjusting content selection section M4, and a set value selection section M5. The setting screen can also be provided with a sample voice reproduction button B1 for reproducing a sample voice and a setting completion button B2 for instructing setting completion.

The use state selection section M1 is adapted to select any one, of the use states U1 to U4 prepared beforehand, that the user desires to make volume and tone quality settings. The user can cause a list of selectable use states to be displayed by clicking a pull-down menu button B3. The user can then select only one use state that the user desires from the list of the selectable use states.

The adjusting device selection section M2 is adapted to select any one, of the adjustment-requiring devices (external microphone 2, earphone 3, mobile terminal microphone 11, mobile terminal ear receiver 12) prepared beforehand, that the user desires to make volume and tone quality adjustments.

The adjusting voice selection section M3 is adapted to select any one, of the voice systems (video voice, voice call) prepared beforehand, that the user desires to make volume and tone quality adjustments.

The adjusting content selection section M4 is adapted to select any one of the adjustment contents (volume, tone quality) prepared beforehand.

The set value selection section M5 is adapted to set any one of the set values (e.g., levels 0 to 5) prepared beforehand.

The example shown in FIG. 6 shows the way the volume of a video voice outputted from the mobile terminal ear receiver 12 is set to level 2 when the mobile terminal is in voice call and video watching U4. When making volume settings, the user can select a desired level by clicking the sample voice reproduction button to reproduce a sample data 34.

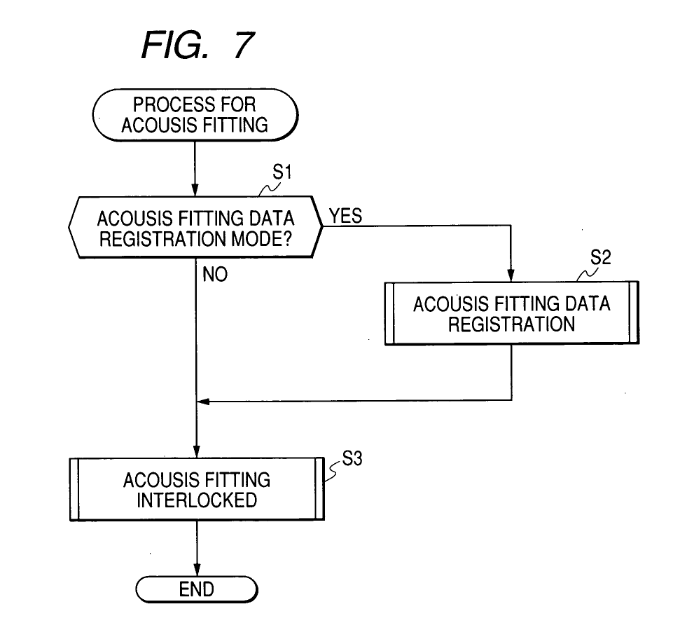

One example of a method for making voice input and output adjustments for a mobile terminal (a acousis fitting method) is described with reference to FIGS. 7 to 9.

FIG. 7 is a schematic flow chart showing an entire process for acousis fitting. When the acousis fitting mode is started first, predetermined initialization processing not shown is performed. A decision is then made as to whether or not a transition is made to an acousis fitting data registration mode (S1).

The acousis fitting data registration mode is a mode for registering volume setting information 32 from the volume setting section 15 and tone quality setting information 33 from the tone quality setting section 16. The user can go to the registration mode (S1: Yes) by making a predetermined operation. If the user selects the registration mode, a process for registering acousis fitting data is performed (S2). The process will be described in detail with reference to another figures.

If the user does not select the acousis fitting data registration mode (S1: No), a process for interlocking acousis fitting (S3) is performed based on acousis fitting data already registered. The details of the process will be further described later.

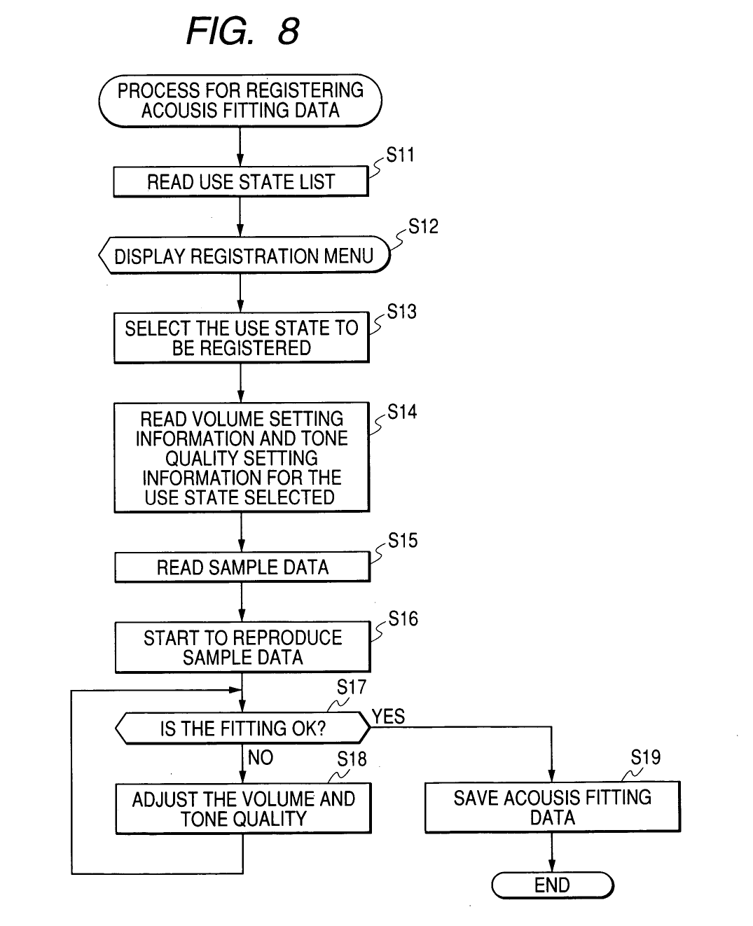

FIG. 8 is a flow chart showing the outline of a process for registering acousis fitting data. The terminal body 10 first reads the use state list information 31 from the memory 30 (S11) and displays the setting screen (registration menus M1 to M5) shown in FIG. 6 (S12).

When the user selects any one of the use states U1 to U4, the terminal body 10 reads, from the memory 30, the volume setting information 32 and tone quality setting information 33 that are registered in association with the use state selected (S14).

The terminal body 10 then reads and reproduces a sample data 34 from the memory 30 if the user desires to reproduce the sample data 34 (S15, S16). The user then adjusts the sample data to the volume and tone quality that he/she likes while checking them. If the user can get a desired fitting data, that is to say, if the user completes selecting the volume and tone quality levels that are comfortable to the ears (S17: Yes), the data is stored as volume setting information 32 and tone quality setting information 33 in the memory 30 (S16).

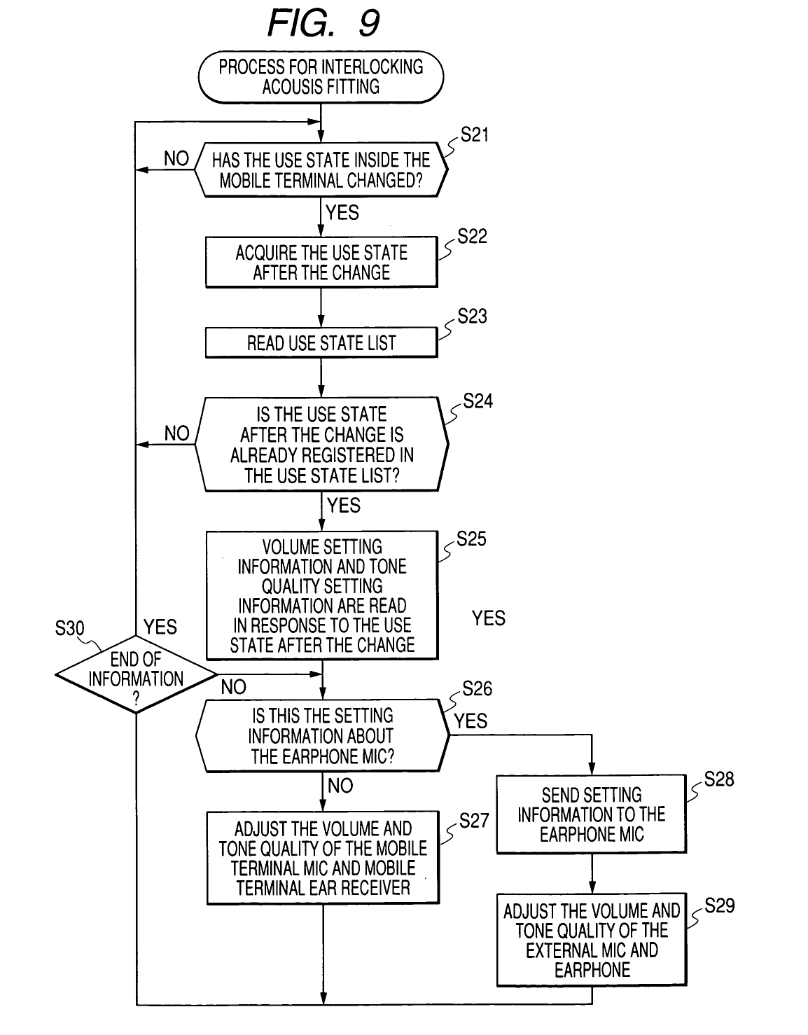

FIG. 9 is a flow chart showing the outline of a process for interlocking acousis fitting. The terminal body 10 watches for a change in a use state in the interior of the mobile terminal as needed (S21). Where a change in the use state appears in the interior of the mobile terminal (S21: Yes), the terminal body 10 acquires the use state after the transition (S22).

The terminal body 10 then reads the use state list information 31 from the memory 30 (S23) and determines whether or not the use state acquired in step S22 is a predetermined use state registered with the use state list information 31 (S24).

If the use state acquired in step S22 is not the predetermined use state registered with the use state list information 31 (S24: No), the process returns to step S21 because the use state acquired is not covered by the process for acousis fitting. If the use state acquired in step S22 is the predetermined use state registered with the use state list information 31 (S24: Yes), the terminal body 10 reads from the memory 30 each of the volume setting information 32 and tone quality setting information 33 corresponding to the use state acquired (S25).

The terminal body 10 then separates setting information on the earphone microphone 1 provided outside the terminal body 10 from the volume setting information 32 and tone quality setting information 33 read from the memory 30 (S26).

If the setting information is about the mobile terminal microphone 11 and mobile terminal ear receiver 12 of the terminal body 10 (S26: No), the terminal body 10 individually adjusts each of the volume and tone quality for the mobile terminal microphone 11 and the mobile terminal ear receiver 12, based on the setting information (S27).

If the setting information is about the earphone microphone 1 (S26: Yes), the terminal body 10 sends the setting information on the earphone microphone 1 to the earphone microphone 1 via the communications section 13 (S28). The earphone microphone 1 individually adjusts the volume and tone quality for the external microphone 2 and the earphone 3, based on the setting information received (S29).

If, as described above, there is a transition in an internal use state of the mobile terminal among the predetermined use states U1 to U4, individual volume and tone quality adjustments are made, according to a use state after the transition, for voice outputs and voice inputs of two or more systems.

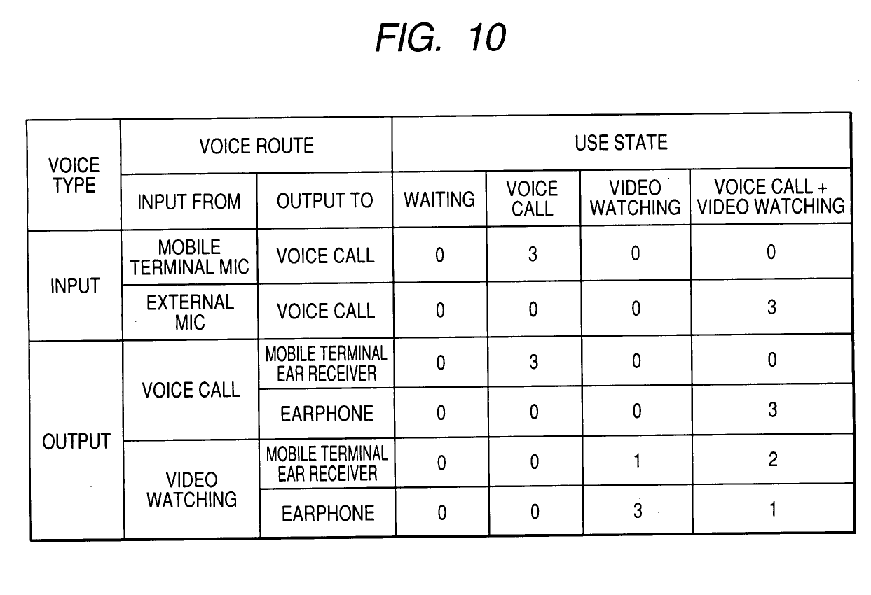

FIG. 10 is an explanatory diagram showing an example of a specific setting of volume setting information 32. The substantial configurations of settings shown in FIGS. 4 and 10 are equal to each other although different expressions are shown in FIGS. 4 and 10.

In the example shown in FIG. 10, the input level for the mobile terminal microphone 11 is, in voice call U2, set to “3” and the output level for voice calls from the mobile terminal ear receiver 12 is set to “3” and the other voice input and output levels are set to “0”. In video watching U3, the output level for video sounds from the mobile terminal ear receiver 12 is set to “1”, the output level for video sounds from the earphone 3 is set to “3”, and the other voice input and output levels are set to “0”. In voice call and video watching U4, the input level for the external microphone 2 is set to “3” and the output level for the mobile terminal microphone 11 is set to “0” while the output level for video sounds from the mobile terminal ear receiver 12 is set to “2” and the output level for video sounds from the earphone 3 is set to “1”. In addition, the output level for voice calls from the earphone 3 is set to “3” and the output level for voice calls from the mobile terminal ear receiver 12 is set to “0”.

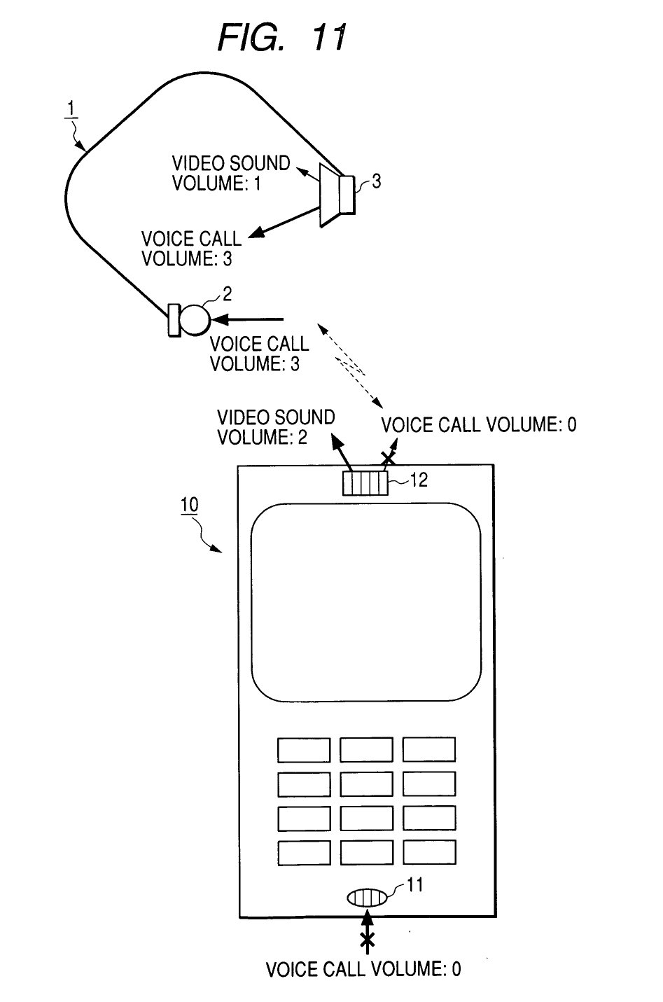

The way the above settings are executed in voice call and video watching U4 is shown in a schematic diagram in FIG. 11. If both voice call and video watching are performed at the same time, voice calls are outputted from the earphone 3 at a volume level of “3” and video sounds are outputted at a volume level of “1”. Only video sounds are outputted from the mobile terminal ear receiver 12 at a volume level of “2”. In addition, the voice input level for the external microphone 2 is set to a volume level of “3” and the mobile terminal microphone 11 is turned off.

If, as described above, both voice call and video watching are performed at the same in the example shown in FIG. 10, voice call from the earphone microphone 1 is set as a master and video watching as a servant. While putting an emphasis on voice call, the user can continue video watching with video sounds audible as a background of voice call and video sounds audible from the mobile terminal ear receiver 12. Note that video watching may be set as a master and voice call as a servant, as opposite to the example of the settings shown in FIGS. 10 and 11. The user can select any type of setting freely.

With the configuration described above, the embodiment has the effects given below. In this embodiment, the mobile terminal is configured to be capable of making automatic volume and tone quality adjustments for voice inputs and outputs, based on use states managed in the interior of the mobile terminal. Even if, therefore, there is a transition in an internal use state, automatic adjustments can be made to a volume and tone quality suitable for use states after the transition, thus saving the trouble of making adjustments manually. This makes the mobile terminal easier to use. Even if, in addition, there are various transitions in internal use states while the user is using his/her mobile terminal, the use of his/her mobile terminal can be continued while deterioration of the environment using the mobile terminal is minimized.

Every year new functions are added particularly to mobile terminals such as cellular phones. The more functions, the more various use states mobile terminals have. As more new mobile terminal use methods are developed, transitions in internal use states can be more various and frequent. In such a case, appropriate volume and tone quality can be, according to this embodiment, set automatically according to the way the user uses his/her mobile terminal, thus making the mobile terminal easier to use.

In this embodiment, the mobile terminal is configured to individually adjust each of the voice input and voice output in two or more systems. Therefore, the user can realize suitable sound environments according to the way the user uses his/her mobile terminal and to his/her tastes by using both the earphone microphone 1 and the terminal body 10 to adjust the volume level for each of the voice input and output.

In particular, if the earphone microphone 1 and the terminal body 10 are connected to each other via radio waves, the user can leave his/her mobile terminal as it is and move relatively freely while wearing the earphone microphone 1. When the user moves, there is a change in a distance between the user and his/her terminal body 10 and in an angle therebetween. Therefore, a voice from the terminal body 10 sounds different and changes in a different way. If the user often leaves his/her mobile terminal as it is and move while wearing only the earphone microphone 1, the user can make volume and tone quality settings with an emphasis on voice inputs and outputs for the earphone microphone 1. If, as described above, the terminal body 10 has another voice input and output system (external microphone 2, earphone 3) separated from the terminal body 10, the usability of the terminal body 10 improves.

If, alternatively, a parent and a child and friends use the terminal body 10 and the earphone microphone 1 separately, for example, the earphone microphone 1 can also be used for voice calls only and the terminal body 10 for video watching only.

Note that the present invention is not limited to the above-mentioned embodiment. Those skilled in the art could make various additions and changes in the scope of the present invention. For example, the mobile terminal is shown herein which has main functions provided on the terminal body 10. Not limited to this configuration, the earphone microphone 1 may be configured to have main functions. For example, the earphone microphone 1 may be configured to have a controller and a memory and to forward video data produced and the like from the earphone microphone 1 to the terminal body 10 for reproduction.

If, for example, a picture phone call is started while digital television available on land broadcasts is watched, automatic adjustments may be made for the display size, displayed position and transmissivity of a television screen displayed on the display and the party's image, besides automatic volume and tone quality adjustments.

For internal use states, waiting, voice call, video watching, and voice call and video watching has been shown as examples. The present invention is not limited to these internal use states. Volume and the like can be automatically adjusted based on the transitions of other internal use states such as a state of photographing with a built-in camera, a state of radio-listening, and a state of game program play, for example.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

1. A mobile terminal comprising a mobile terminal body having at least a voice input section and a voice output section, and an external unit connected to the mobile terminal body and having at least another voice input section and another voice output section, the mobile terminal comprising:
a storage section for storing adjustment information pre-registered for each predetermined internal use state managed in the interior of the mobile terminal;
a use state acquisition section for acquiring a change in the internal use state managed in the interior of the mobile terminal; and
an adjustment section, if said internal use state acquired is said predetermined internal use state, for reading out the adjustment information corresponding to the predetermined internal use state from said storage section and, based on the adjustment information, adjusting at least one of an input state of said individual voice input section and an output state of said voice output section.

2. The mobile terminal according to claim 1, wherein said adjustment section is capable of individually adjusting each of volume and tone quality.

3. The mobile terminal according to claim 1, wherein each piece of said adjustment information contains an set value for adjustment provided for each output system of each of said voice output sections.

4. The mobile terminal according to claim 1, wherein said adjustment section is capable of individually adjusting each of said voice input sections and each of said voice output sections.

5. The mobile terminal according to claim 1, wherein said adjustment section is provided for each of said mobile terminal body and said external unit.

6. The mobile terminal according to claim 1, further comprising a state change detection section for detecting a change in said internal use state;
wherein if said state change detection section detects the change in said internal use state, said use state acquisition section acquires said internal use state after the change.

7. The mobile terminal according to claim 1, wherein said storage section includes a registration section for registering each piece of said adjustment information.

8. The mobile terminal according to claim 1, wherein said internal use state includes at least both waiting state and voice call state.

9. The mobile terminal according to claim 1, wherein said mobile terminal body further includes a video output section, and said predetermined internal use state includes at least two or more states of waiting state, voice call state, video watching state, and voice call and video watching state.

10. The mobile terminal according to claim 1, wherein said storage section is removably provided for said mobile terminal body.

11. The mobile terminal according to claim 1, wherein said external unit is configured as a headset or an earphone microphone.

12. A voice output adjustment method for adjusting a voice output of a mobile terminal, the method comprising the step of:
storing adjustment information for each predetermined internal use state managed in the interior of the mobile terminal;
storing each piece of said adjustment information registered;
detecting a change in an internal use state managed in the interior of said mobile terminal;
acquiring an internal use state after the change, based on the internal use state detected;
determining whether or not the internal use state detected is said predetermined internal use state;
reading out said adjustment information corresponding to said predetermined internal use state if the internal use state detected is determined to be said predetermined internal use state; and
individually adjusting each voice output of a plurality of voice output systems, based on the adjustment information read out.
